(19) United States
(12) Patent Application Publication
(10) Pub. No.: US 2013/0276120 A1
(43) Pub. Date: Oct. 17, 2013

(54) SYSTEM, METHOD, AND COMPUTER PROGRAM PRODUCT FOR DETERMINING WHETHER A SECURITY STATUS OF DATA IS KNOWN AT A SERVER

(71) Applicants: Gregory William Dalcher, Tigard, OR (US); Jonathan L. Edwards, Portland, OR (US)

(72) Inventors: Gregory William Dalcher, Tigard, OR (US); Jonathan L. Edwards, Portland, OR (US)

(21) Appl. No.: 12/131,383

(22) Filed: Jun. 2, 2008

(51) Int. Cl. G06F 21/24; G06F 17/00; H04L 9/00

(52) U.S. Cl. 726/24; 726/22

(57) ABSTRACT

A system, method, and computer program product are provided for determining whether a security status of data is known at a server. In use, a request for a security status of data is received over a network at a server. Additionally, it is determined whether the security status is known at the server using at least one of a whitelist and a blacklist. Furthermore, a result of the determination is transmitted over the network.

### FIELD OF THE INVENTION

The present invention relates to data analysis, and more particularly to analyzing data for determining a security of the data.

### BACKGROUND

Traditionally, security systems have been employed for analyzing data to determine a security of the data. Oftentimes, such analysis is performed for detecting malware. However, techniques utilized by traditional security systems for determining the security of data have exhibited various limitations. Just by way of example, the determination of the security of data has generally been performed locally, thus requiring a system storing the data to further store information (e.g. rules, etc.) utilized in making the determination of the security of the data.

There is thus a need for addressing these and/or other issues associated with the prior art.

### SUMMARY

A system, method, and computer program product are provided for determining whether a security status of data is known at a server. In use, a request for a security status of data is received over a network at a server. Additionally, it is determined whether the security status is known at the server using at least one of a whitelist and a blacklist. Furthermore, a result of the determination is transmitted over the network.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for determining whether a security status of data is known at a server, in accordance with one embodiment.

FIG. 4 shows a system for determining whether a security status of data is known at a server, in accordance with another embodiment.

FIG. 5 shows a method for determining whether data is whitelisted or blacklisted, in accordance with yet another embodiment.

FIG. 6 shows a method for determining a security status of data, in accordance with still yet another embodiment.

FIG. 7 shows a method for utilizing a user interaction to determine a security status of data, in accordance with another embodiment.

FIG. 8 shows a method for selecting data for which to determine a security status thereof, in accordance with yet another embodiment.

### DETAILED DESCRIPTION

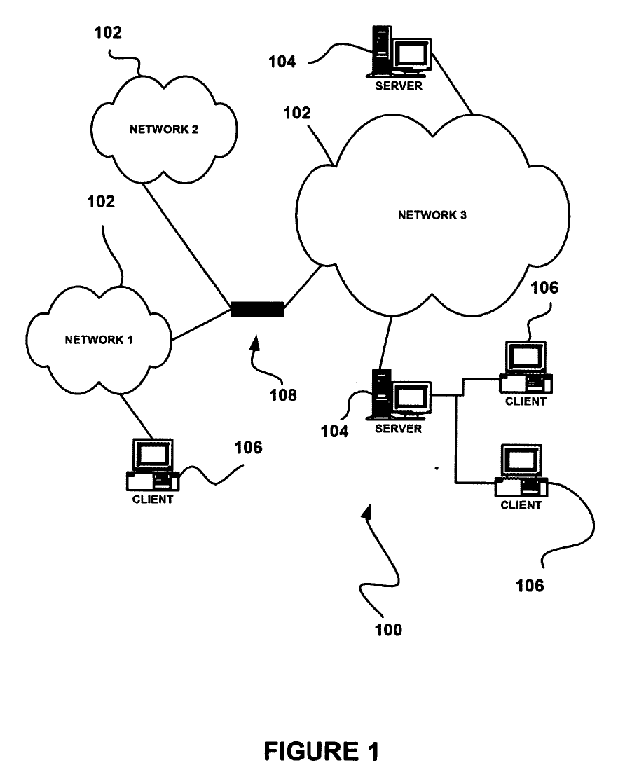

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

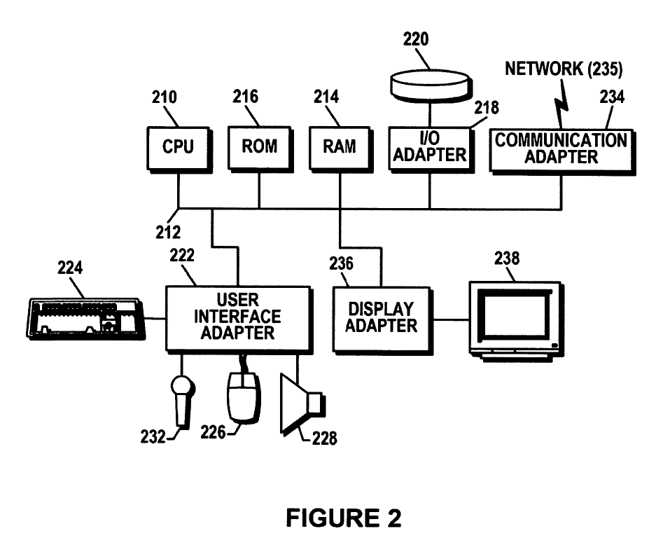

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

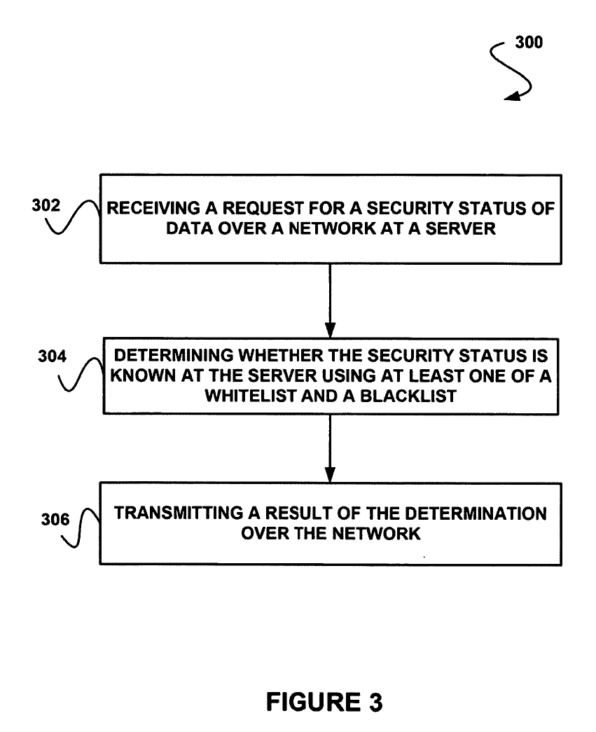

FIG. 3 shows a method 300 for determining whether a security status of data is known at a server, in accordance with one embodiment. As an option, the method 300 may be carried out in the context of the architecture and environment of FIGS. 1 and/or 2. Of course, however, the method 300 may be carried out in any desired environment.

As shown in operation 302, a request for a security status of data is received over a network at a server. With respect to the present description, the data may include any information, code, file, etc. capable of having a security status associated therewith. Just by way of example, the data may include an executable file.

In one embodiment, the security status of the data may identify whether the data is wanted or unwanted. As an option, the data may be unwanted if the data includes malware. As another option, the data may be wanted if the data is not malware. To this end, the security status may include information associated with whether the data is wanted or unwanted.

In another embodiment, the security status may identify whether the data is allowed to be executed or disallowed from being executed. The data may be allowed to be executed if the data is wanted, for example. As another example, the data may be disallowed from being executed if the data is unwanted.

In another embodiment, the security status may identify whether the data is allowed to be accessed (e.g. opened, moved, copied, etc.). As an option, the data may be allowed to be accessed if the data is wanted. As another option, the data may be disallowed from being accessed if the data is unwanted.

In still yet another embodiment, the security status may identify whether monitoring of the data is to be performed during execution of the data. For example, the security status may optionally indicate that the execution of the data is allowed and further that the execution of the data is to be monitored. As an option, the security status may additionally identify a level (e.g. type, etc.) of monitoring to be performed during the execution of the data.

While various embodiments of the security status have been described above, it should be noted that the security status may include any information indicating a status of the security of the data. Table 1 illustrates various examples of a security status of data. It should be noted that such exemplary security statuses are set forth for illustrative purposes only, and thus should not be construed as limiting in any manner.

TABLE 1
1. The data is wanted-allow the data to be executed and monitor the
execution utilizing a default level of monitoring
2. The data is wanted-allow the data to be executed and monitor the
execution utilizing an increased level of monitoring
3. The data is wanted-allow the data to be executed and do not monitor
the execution (for compatibility and/or performance purposes)
4. The data is unwanted-disallow execution of the data

Further, the request for the security status of the data may optionally be received over the network at the server in response to an attempt to access the data, execute the data, etc. For example, the request may be automatically generated and sent to the server over the network by another device (e.g. client, etc.) via which the data is attempted to be executed. With respect to the present description, such server may include any server device capable of determining whether the security status is known at the server using at least one of a whitelist and a blacklist, as described below.

As an option, the request may include any information associated with the data. In various embodiments, the request may include a hash [e.g. Message-Digest algorithm 5 (MD5)] of the data, a hash of a portion of the data, a name of the data, a size of the data, etc. In another embodiment, the request may include information identifying a source of the data, such as a creator of the data, a location (e.g. website, etc.) from which the data was received by the client attempting to execute the data, etc.

In addition, as shown in operation 304, it is determined whether the security status is known at the server using at least one of a whitelist and a blacklist. In one embodiment, the whitelist may include a list of data (e.g. or hashes, digital signatures, etc. thereof) predetermined to be allowed to be executed. For example, the whitelist may indicate data predetermined to be wanted.

In another embodiment, the blacklist may include a list of data (e.g. or hashes, digital signatures, etc. thereof) predetermined to be disallowed from being executed. For example, the blacklist may indicate data predetermined to be unwanted. As an option, the whitelist and/or blacklist may be manually or automatically generated.

Moreover, determining whether the security status is known at the server may include determining whether the security status is determinable utilizing the whitelist and/or blacklist at the server. Accordingly, the whitelist and/or blacklist may be stored at the server. For example, it may be determined that the security status is known at the server if the security status is determinable (e.g. is capable of being identified) utilizing the whitelist and/or blacklist. As another example, it may be determined that the security status is not known at the server if the security status is indeterminable (e.g. is not capable of being identified) utilizing the whitelist and/or blacklist.

Thus, in one optional embodiment, determining whether the security status is known at the server may include determining whether the data is included in whitelist and/or blacklist. For example, determining whether the security status is known at the server may optionally include determining that the whitelist or blacklist stored on the server includes the data.

In one embodiment, the determination may include comparing the data to the whitelist and/or blacklist. If the data is included in the whitelist, it may be determined that the data is known to be wanted, allowed to be executed, etc. If the data is included in the blacklist, it may be determined that the data is known to be unwanted, disallowed from being executed, etc. Of course, however, it may be determined whether the security status is known at the server in any manner that uses the whitelist and/or the blacklist.

Still yet, a result of the determination is transmitted over the network, as shown in operation 306. With respect to the present description, the result of the determination may include any information indicating whether the security status is known at the server. For example, the result may include that the security status is known or that the security status is unknown.

Furthermore, the result of the determination may be transmitted over the network to any desired device. As an option, the device to which the result is transmitted may be selected based on the result. For example, if the result is that the security status is known at the server, the result may be transmitted to a first device. As another example, if the result is that the security status is unknown, the result may be transmitted to a second device separate from the first device.

In one embodiment, the result of the determination may be transmitted to a device from which the request for the security status was received. For example, the result of the determination may be transmitted to a device from which the request for the security status was received if the result is that the security status is known at the server. Optionally, transmitting the result to such device may include transmitting the security status to the device.

In another embodiment, the result of the determination may be transmitted to another server. For example, the result of the determination may be transmitted to the other server if the result is that the security status is unknown at the server. Such other server may include a parent to the server in a hierarchical server structure.

Just by way of example, if the server includes an enterprise server, the result of the determination may be transmitted to a super server which is in communication with a plurality of enterprise servers. As an option, transmitting the result of the determination to such other server may include transmitting a request for the security status to the other server. In this way, the security status may be requested from any number of different servers based on a hierarchical ordering of such servers, until such security status is determined to be known or until it is determined that the security status is unknown at all servers in the hierarchical order.

If the server receives a result that the security status is known at the other server, the security status may be received from such other server (e.g. with the result) at the server and stored in a cache at the server. Furthermore, the security status may be forwarded to the device from which the request for the security status was received by the server (operation 302). Thus, the server may optionally update a whitelist or blacklist of the server utilizing the received security status of the data. For example, if the security status indicates that the data is wanted, the server may update the whitelist to include such data. As another example, if the security status indicates that the data is unwanted, the server may update the blacklist to include the data.

In one exemplary embodiment, if the security status is determined to be unknown at all servers in the hierarchical order, a result of such determination may be transmitted to the device from which the request for the security status was received. The result may indicate that the data is unknown (e.g. not known to be wanted and not known to be unwanted). As another option, the result may request additional information from the device from which the request for the security status was received. The additional information requested may include any information not originally received by the server from the device in operation 302, for example. In various embodiments the additional information may include a sample of the data, a request for a different type of hash of the data than that originally sent by the device to the server, a digital signature, etc.

To this end, the result of the determination of whether the security status of the data is known at the server may be transmitted over the network in response to receipt of the request for such security status at the server. Utilizing the server to determine whether the security status is known may optionally allow regular updates to the whitelist and/or blacklist of the server, and optionally of the device from which the request for the security status was received by the server, which responsive to a generation of such updates to be avoided, thus limiting bandwidth and/or resource consumption.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

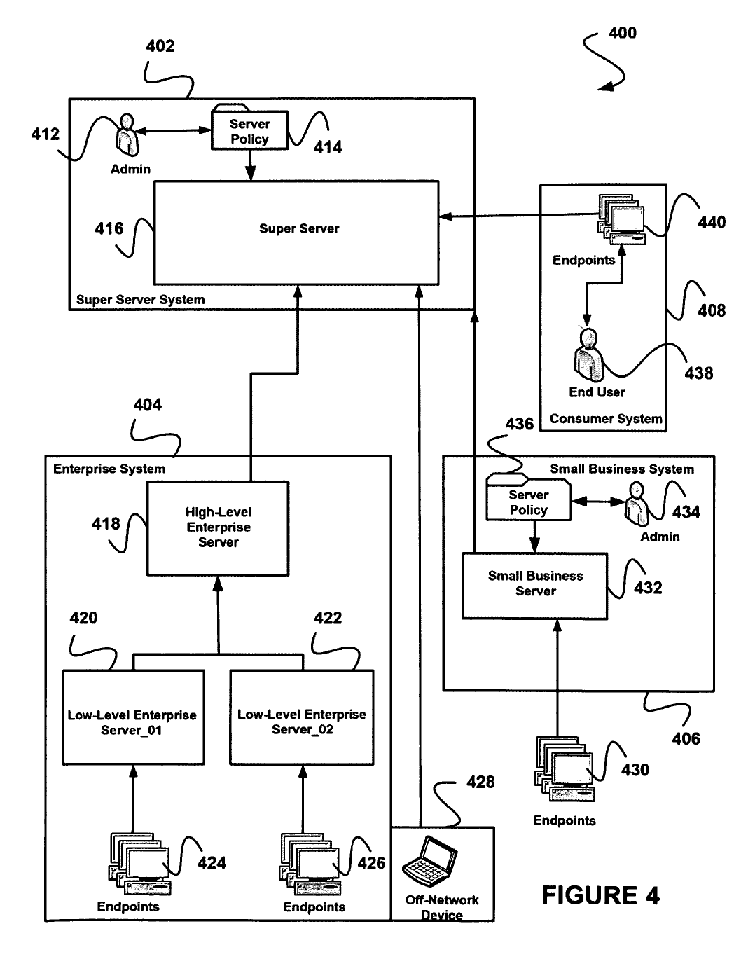

FIG. 4 shows a system 400 for determining whether a security status of data is known at a server, in accordance with another embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As shown, a super server system 402 is in communication with each of an enterprise system 404, a small business system 406, a consumer system 408 and an off-network device 428. In one embodiment, the super server system 402 may communicate with each of such enterprise system 404, small business system 406, consumer system 408 and off-network device 428 via any number of different networks. For example, such networks may include any of the networks described above with respect to FIG. 1.

The super server system 402 may include a highest system in a hierarchy of systems. For example, as shown, the super server system 402 may be central to the enterprise system 404, small business system 406, consumer system 408 and off-network device 428. As an option, the super server system 402 may be managed by a security system provider.

Additionally, the super server system 402 includes a super server 416. The super server 416 may be utilized for determining whether data is wanted or unwanted. For example, a server policy 414 of the super server system 402 may be configured with a whitelist and/or a blacklist for indicating data that is predetermined to be wanted and/or unwanted, respectively. Optionally, an administrator 412 of the super server system 402 may configure which data is included in the whitelist and/or blacklist. Of course, as another option, the whitelist and/or blacklist may be automatically configured with the data included therein.

Further, the enterprise system 404 may include a plurality of enterprise servers 418, 420, and 422. As shown, the servers 418, 420, and 422 of the enterprise system 404 may be ordered hierarchically. Thus, a high-level enterprise server 418 may be a parent to a plurality of low-level enterprise servers 420 and 422. Moreover, each of the low-level enterprise servers 420 and 422 may be in communication with different sets of endpoint devices 424 and 426, as an option. The each of the endpoint devices 424 and 426 may be utilized by users of the enterprise system 404, for example.

Thus, in one embodiment, a user of an endpoint device 424 and 426 may attempt to execute data stored on such endpoint device 424 and 426. Prior to allowing such execution, a security system of the endpoint device 424 and 426 may automatically determine whether a security status of the data is known at the endpoint device 424 and 426. For example, the security system of the endpoint device 424 and 426 may compare the data to a whitelist and/or a blacklist located on such endpoint device 424 and 426.

If the security system of the endpoint device 424 and 426 determines that the security status is known, the security system may instruct the endpoint device 424 and 426 to allow or disallow the execution of the data, based on the security status. For example, if the security status of the data indicates that the data is wanted, execution of the data may be allowed. As another example, if the security status of the data indicates that the data is unwanted, execution of the data may be disallowed (e.g. prevented, blocked, etc.).

If the security system of the endpoint device 424 and 426 determines that the security status is unknown, the endpoint device 424 and 426 may transmit a request for such security status to the low-level enterprise server 420 and 422 associated therewith. The low-level enterprise server 420 and 422 may accordingly determine whether the security status of the data is known at such low-level enterprise server 420 and 422, utilizing a whitelist and/or blacklist located thereon. As an option, the endpoint device 424 and 426 may transmit the request for the security status to the low-level enterprise server 420 and 422 over a network. The request may optionally include the data, a hash of the data, etc.

Further, the low-level enterprise server 420 and 422 transmits a result of the determination over a network. In one embodiment, if the low-level enterprise server 420 and 422 determines that the security status of the data is known, the low-level enterprise server 420 and 422 may transmit a result indicating the security status of the data to the endpoint device 424 and 426 requesting such security status. As an option, the endpoint device 424 and 426 may store the data in one of the whitelist and blacklist located thereon, according to the received security status (e.g. in the whitelist if the security status is that the data is wanted and in the blacklist if the security status is that the data is unwanted). The endpoint device 424 and 426 may also allow or disallow execution of the data, based on the received security status.

In another embodiment, if the low-level enterprise server 420 and 422 determines that the security status of the data is unknown, the low-level enterprise server 420 and 422 may transmit a request for such security status to the high-level enterprise server 418. The request may optionally include the data, a hash of the data, etc. Accordingly, the high-level enterprise server 418 may determine whether the security status of the data is known at the high-level enterprise server 418, utilizing a whitelist and/or blacklist located on such high-level enterprise server 418.

Moreover, the high-level enterprise server 418 may transmit a result of determination over a network. In one embodiment, if the high-level enterprise server 418 determines that the security status of the data is known, the high-level enterprise server 418 may transmit a result indicating the security status of the data to the low-level enterprise server 420 and 422 from which the request was received. The low-level enterprise server 420 and 422 may optionally store the data in one of the whitelist and blacklist located thereon, according to the received security status (e.g. in the whitelist if the security status is that the data is wanted and in the blacklist if the security status is that the data is unwanted).

Further, the low-level enterprise server 420 and 422 may transmit the result received from the high-level enterprise server 418 to the endpoint device 424 and 426 from which the request for the security status of the data was originally received. Optionally, the endpoint device 424 and 426 may also store the data in one of the whitelist and blacklist located thereon, according to the received security status. The endpoint device 424 and 426 may furthermore allow or disallow execution of the data, based on the received security status.

In another embodiment, if the high-level enterprise server 418 determines that the security status of the data is unknown, the high-level enterprise server 418 may transmit a request for the security status of the data to the super server 416 of the super server system 402. The request may optionally include the data, a hash of the data, etc. Accordingly, the super server 416 may determine whether the security status of the data is known at the super server 416, utilizing a whitelist and/or blacklist located on such super server 416.

Moreover, the super server 416 may transmit a result of determination over a network to the high-level enterprise server 418. In one embodiment, if the super server 416 determines that the security status of the data is known, the super server 416 may transmit a result indicating the security status of the data to the high-level enterprise server 418 from which the request was received. The high-level enterprise server 418 may optionally store the data in one of the whitelist and blacklist located thereon, according to the received security status (e.g. in the whitelist if the security status is that the data is wanted and in the blacklist if the security status is that the data is unwanted).

Still yet, the high-level enterprise server 418 may transmit the result received from the super server 416 to the low-level enterprise server 420 and 422 from which the request was received. The low-level enterprise server 420 and 422 may optionally store the data in one of the whitelist and blacklist located thereon, according to the received security status (e.g. in the whitelist if the security status is that the data is wanted and in the blacklist if the security status is that the data is unwanted). Furthermore, the low-level enterprise server 420 and 422 may transmit the security status received from the high-level enterprise server 418 to the endpoint device 424 and 426 from which the request for the security status of the data was originally received. Optionally, the endpoint device 424 and 426 may also store the data in one of the whitelist and blacklist located thereon, according to the received security status. The endpoint device 424 and 426 may furthermore allow or disallow execution of the data, based on the received security status.

In another embodiment, if the super server 416 determines that the security status of the data is unknown, the super server 416 may transmit a result indicating that the security status of the data is unknown to the high-level enterprise server 418 from which the request was received. The result may further request additional information associated with the data. The high-level enterprise server 418 may forward such result to the low-level enterprise server 420 and 422, which may in turn further forward the result to the endpoint device 424 and 426.

Upon receipt of the result indicating that the security status of the data is unknown by the endpoint device 424 and 426, the endpoint device 424 and 426 may respond with the additional information requested by the super server 416. As an option, the additional information may be sent to the super server 416 via the low-level enterprise server 420 and 422 and further via the high-level enterprise server 418. In this way, the super server 416 may analyze the additional data utilizing the server policy 414 for determining a security status of the data. Of course, as another option, the administrator 412 of the super server system 402 may also manually analyze the additional data for determining a security status of the data. A determination of the security status of the data may be further be transmitted to the endpoint device 424 and 426 (e.g. via the high-level enterprise server 418 and the low-level enterprise server 420 and 422).

By optionally transmitting the security across hierarchically ordered servers, any server via which the security status is transmitted to the endpoint device 424 and 426 may store (e.g. in cache) the security status for the data, such that any subsequent request for the security status of the data (e.g. by a different endpoint device 424 and 426, etc.) may result in a determination that the security status of the data is known at such server. Similarly, the endpoint device 424 and 426 may also stored security status of the data that is received in response to a request therefor, such that the security status may be automatically determined at the endpoint device 424 and 426 in response to a subsequent attempt to execute the data.

As also shown, each endpoint device 440 controlled by an end user 438 of the consumer system 408 may directly send a request for a security status of data attempted to be executed by such endpoint device 440 to the super server 416. For example, in response to an attempt by the endpoint device 440 of the consumer system 408 to execute data, a security system of the endpoint device 440 may automatically determine whether the security status of the data is known at the endpoint device 440. For example, the security system of the endpoint device 440 may compare the data to a whitelist and/or a blacklist located on such endpoint device 440.

If the security system of the endpoint device 440 determines that the security status is known, the security system may instruct the endpoint device 440 to allow or disallow the execution of the data, based on the security status. For example, if the security status of the data indicates that the data is wanted, execution of the data may be allowed. As another example, if the security status of the data indicates that the data is unwanted, execution of the data may be disallowed.

If the security system of the endpoint device 440 determines that the security status is unknown, the endpoint device 440 may transmit a request for such security status directly to the super server 418. The super server 418 may accordingly determine whether the security status of the data is known at such super server 418, utilizing server policy 414. As an option, the endpoint device 440 may transmit the request for the security status to the super server 418 over a network. The request may optionally include the data, a hash of the data, etc. In this way, the super server 418 may transmit a result of a determination of whether the security status is known to the endpoint device 440 of the consumer system 408 (e.g. indicating the security status if the security status is known at the super server 416, requesting additional information if the security status is unknown at the super server 416, etc.).

Similarly to the manner described above with respect to the endpoint device 440 of the consumer system 408, the off-netxvork device 428 may also directly send a request for a security status of data attempted to be executed by such off-network device 428 to the super server 416. With respect to the present embodiment, the off-network device may include any device that is not connected to a LAN and which is in direct communication with the super server 416 via a network (e.g. the Internet, etc.). Accordingly, the off-network device 428 may receive a result of a determination by the super server 416 regarding whether the security status is known at the super server 416.

Still yet, a plurality of endpoint devices 430 of a small business system 406 may be in communication with the super server 416 via a small business server 432 of the small business system 406. The small business system 406 may include a system that is smaller than the enterprise system 404 (e.g. including less devices, etc.), for example. The small business server 432 may be capable of determining whether a security status of data is known, utilizing a server policy 436 of the small business system 406. Such server policy 436 may be configured by an administrator of the small business system 406, as an option.

Thus, in response to an attempt by a user of one of the endpoint devices 430 of a small business system 406 to execute data via the endpoint device 430, a security system of the endpoint device 430 may automatically determine whether a security status of the data is known at the endpoint device 430. For example, such determination may utilize a whitelist and/or blacklist stored on the endpoint device 430.

If it is determined by the security system that security status is known, the security system may instruct the endpoint device 430 to allow or disallow the execution of the data, based on the security status. For example, if the security status of the data indicates that the data is wanted, execution of the data may be allowed. As another example, if the security status of the data indicates that the data is unwanted, execution of the data may be disallowed.

If the security system of the endpoint device 430 determines that the security status is unknown, the endpoint device 430 may transmit a request for such security status to the small business server 432. The small business server 432 may accordingly determine whether the security status is known at the small business server 432, utilizing the server policy 436 of the small business system 406. Thus, the small business server 432 may transmit a result of the determination over a network.

In one embodiment, if the security status is known at the small business server 432, the small business server 432 may transmit the security status to the endpoint device 430, such that the endpoint device 430 may accordingly allow or disallow the execution of the data based on the security status. The endpoint device 430 may also optionally store the data in a whitelist or blacklist of the endpoint device 430, based on the received security status.

In another embodiment, if the security status is unknown at the small business server 432, the small business server 432 may transmit a request for the security status to the super server 416. To this end, the super server 418 may transmit a result of a determination of whether the security status is known to the endpoint device 430 of the small business system 406 via the small business server 432 (e.g. indicating the security status if the security status is known at the super server 416, requesting additional information if the security status is unknown at the super server 416, etc.).

As an option, each of the endpoint devices, servers, etc. in the system 400 may associated with a whitelist and/or a blacklist. The whitelist and/or a blacklist may be manually configured by an administrator, in one embodiment. In another embodiment, as noted above, the whitelist and/or a blacklist may also be automatically updated based on received security statuses. In this way, a manually configured whitelist and/or a blacklist may be merged with data for which a security status is received.

As another option, prior to transmitting a request for a security status of data to the super server 416, the enterprise system 404, the consumer system 408, the small business system 406 or the off-network device 428 from which the request is to be transmitted may determine whether the data is sensitive (e.g. confidential, etc.) data. If the data is sensitive, transmittal of the request may be automatically prevented (e.g. based on a policy), for preventing unwanted disclosure of the data at the super server system 402. Of course, an administrator of the respective enterprise system 404, the consumer system 408, the small business system 406 or the off-network device 428 may manually approve transmittal of the request, thus overriding the automatic blocking of such transmittal.

As another option, when the super server 416 (or any of the other servers in the system 400) transmits a result of a requested security status of data, the super server 416 may include at least one security status associated with other data. The other data for which the security status thereof is sent may be selected in any desired manner. In one embodiment, the other data may be selected based on an identifier thereof stored in association with the data in the whitelist and/or blacklist utilized to determine the security status of such data. For example, the entry of the data in the whitelist and/or blacklist may be tagged or bundled with a cache of the other data. In other embodiments, the other data may be associated with the data for which the security status is requested (e.g. may be utilized by an application which utilizes the data for which the security status is requested, etc.), may include a variant of the data, etc. In this way, security statuses of other data not necessarily attempted to be executed by an endpoint device may be transmitted to the endpoint device (e.g. via at least one server, etc.).

Just by way of example, if an endpoint device attempts to execute “excel.exe”, the endpoint device may calculate a hash of “excel.exe” and transmit such hash to a server. The response to such request received by the endpoint device may indicate whether “excel.exe” is wanted. However, the response may also contain information about “OGL.DLL”, “MSORES.DLL” and “OART.DLL”, including hashes thereof and an indication of whether such data is wanted. When these dynamic link library (DLL) files are subsequently loaded by an application, a security status of such DLLs will already be present on the endpoint device and a transmittal of a request for such security statuses may be avoided.

As yet another option, the super server 416 may provide security statuses of data that are not necessarily requested to servers and/or endpoint devices. As an option, such security statuses may be provided to any device in response to a determination that such device is in an idle state, that resources (e.g. memory, CPU, network bandwidth, etc.) utilized by the device is below a threshold level, etc. The data for which the security statuses are provided may be selected in any desired manner (e.g. in response to a determination that such device is in an idle state, etc. as noted above).

In one embodiment, the data may be selected based on a calculated probability that the data will be subsequently accessed, executed, etc. (e.g. within a predetermined period of time, etc.). For example, the data may be selected based on data that is currently being processed. As another example, the data may be selected based on data that has been previously accessed (e.g. within a predetermined period of time, etc.). Optionally, the previous access may be determined utilizing a date and/or time of previous access maintained by file system.

As yet another example, the data may be selected utilizing prefetch information (e.g. provided by an operating system, etc.). The prefetch information may indicate data utilized during startup of a process. Thus, data indicated by the prefetch information may be selected. As still yet another option, the data may be selected based on data previously installed (e.g. within a predetermined period of time, etc.), an upgrade installed, etc.

Requesting a security status of data from a server based on a hierarchical ordering of a plurality of servers if the security status of the data is unknown at a current device attempting to determine the security status may minimize and/or eliminate unnecessary data being sent to an endpoint accessing the data, may prevent transmittal of security statuses associated with data that may not necessarily be utilized by the endpoint, may avoid cumbersome one-time downloads of numerous security statuses which may introduce latency at the endpoint and potential bottlenecking at the server providing the security statuses, may provide a security status in real-time based on a request for such status, etc.

Furthermore, complexity for the super server 416 may be avoided by eliminating maintenance of a configuration of the endpoint devices at the server, eliminating maintenance of multiple lists of security statuses to be provided to different endpoint devices, eliminating customization of a response to a security status request from an endpoint based on endpoint characteristics

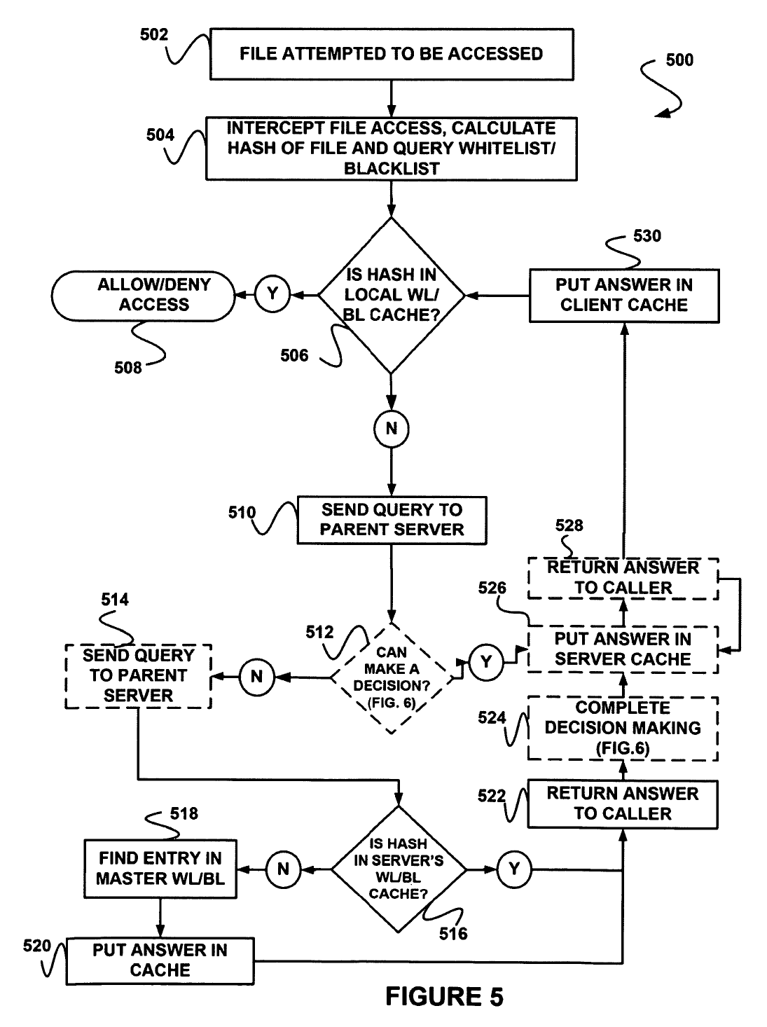

FIG. 5 shows a method 500 for determining whether data is whitelisted or blacklisted, in accordance with yet another embodiment. As an option, the method 500 may be carried out in the context of the architecture and environment of FIGS. 1-4. Of course, however, the method 500 may be carried out in any desired environment. Again, it should be noted that the aforementioned definitions may apply during the present description.

As shown in operation 502, a file is attempted to be accessed. With respect to the present embodiment, the attempted access to the file may include any desired type of access, such as opening the file, reading the file, etc. As an option, the file may be attempted to be accessed locally. As another option, the attempt to access the file may be identified by monitoring access requests associated with the file.

In one embodiment, the file may include an executable file, and the attempted access may include an attempt to execute the file. Just by way of example, the attempted access may be initiated by a user double clicking on the executable file. The user may include any user of a device via which an executable file may be selected to execute. For example, the double click of the executable file may be a request to initiate execution of the executable file.

Access to the file is intercepted, a hash of the file is calculated and a whitelist and blacklist of the device on which the file is located are queried. Note operation 504. In one embodiment, the access to the file may be intercepted by intercepting a request for the access to the file. In another embodiment, if the file is an executable file the access to the file may be intercepted by intercepting creation of a process associated with the access to the file. For example, the process which is intercepted may include a process to be utilized for executing the executable file, for example. In addition, the whitelist and blacklist may be stored in a cache and queried utilizing the calculated hash.

Further, it is determined whether the hash is included in the local whitelist or blacklist, as shown in decision 506. In one embodiment, the local whitelist and/or blacklist may be included in a local cache. The local cache may include the whitelist and blacklist of the device on which the file is located, for example.

If it is determined that the hash is included in the local whitelist or blacklist, access to the file may be respectively allowed or denied, as shown in operation 508. For example, if it is determined that the hash is included in the local whitelist, the access to the file may be allowed. However, if it is determined that the hash is included in the local blacklist, the access to the file may be denied. In another optional embodiment, the hash may also be compared to a list of data for which additional monitoring is to be performed. Thus, if the hash is included in such list, access to the file may be allowed while performing additional monitoring of the file.

If it is determined that the hash is not included in the local whitelist and/or blacklist cache (or optionally the list of data for which additional monitoring is to be performed), a query is sent to a parent server, as shown in operation 510. The parent server may include a server in direct communication with the device via which the file was attempted to be accessed (in operation 502), and which is an immediate next server in a hierarchical ordering of servers. In one embodiment, the query may include a request for security status of the executable file.

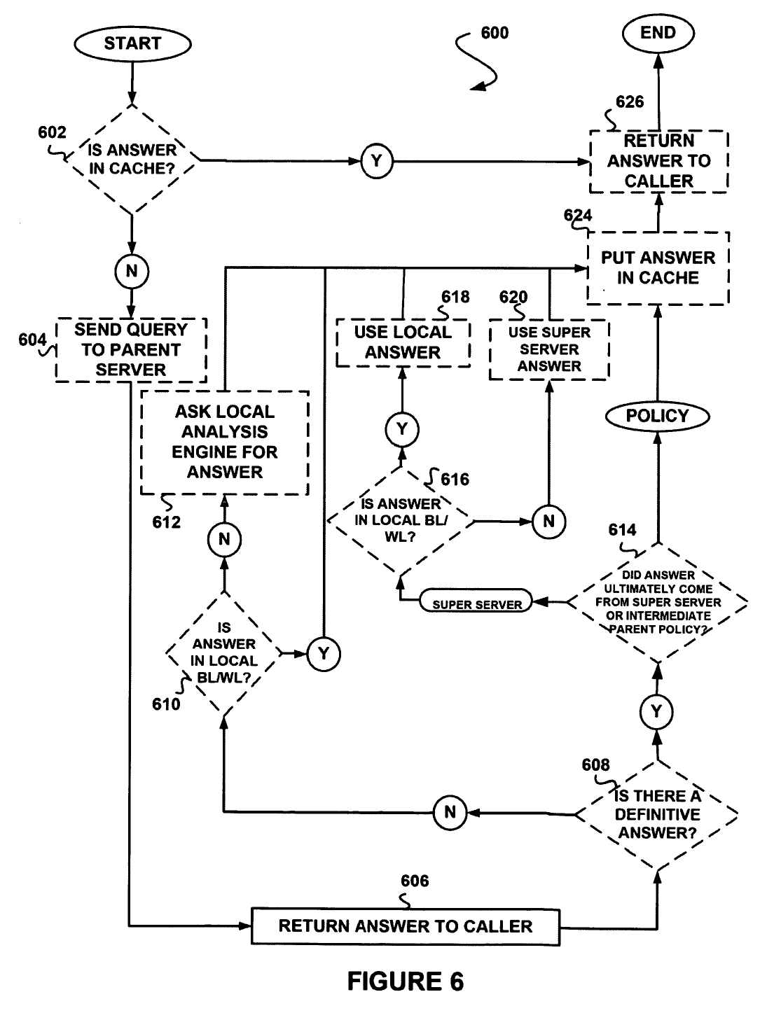

Moreover, it is determined in decision 512 whether the parent server determines that the security status of the file is known (e.g. whether the parent server knows the security status of the file). One example of a method in which the parent server may determine whether the security status is known is shown in FIG. 6. Of course, however, the determination may be made in any desired manner.

If it is determined that the security status is unknown at the parent server, a query for such security status is sent to a next parent server based on the hierarchical ordering of servers, as shown in operation 514. Thus, it is determined whether the hash is included in the whitelist and blacklist cache (or optionally a list of data for which additional monitoring is to be performed) of such next parent server, as shown in decision 516. In this way, it may be determined whether the security status is known at the next parent server. It should be noted that operations 512-516 may be repeated any desired number of time for each additional parent server in the hierarchy, until the server at the highest point in the hierarchy which includes a master whitelist and blacklist (and optionally the list of data for which additional monitoring is to be performed) is reached (see FIG. 6, for example).

If it is determined that the security status is known at the parent server, the security status of the file is optionally stored in a cache of the parent server, as shown in operation 526. For example, the file (or a hash thereof) may be stored in a whitelist or blacklist cache of the parent server (or optionally the list of data for which additional monitoring is to be performed), based on the security status. In this way, the parent server may utilize the cache for increased speed in determining whether the security status of the file is known in response to a next query received by the parent server.

In addition, the security status is returned to the caller which sent the query. Note operation 528. As shown, operations 526 and 528 may be repeated for each server which determined that the security status was unknown, until the security status is returned down the hierarchy to the device via which the file was attempted to be accessed. In this way, each server and the device which via which the file was attempted to be accessed that determined that the security status was unknown may store the security status for future use. See operation 530. For example, in response to storing the security status of the file at the device which via which the file was attempted to be accessed, the file may be allowed (e.g. with additional monitoring performed thereon) or disallowed from being accessed based on such security status (e.g. see decision 506 and operation 508).

If it is determined that the security status is unknown at the parent server, and that the next server is the server which includes the master whitelist and blacklist (and/or optionally the list of data for which additional monitoring is to be performed), the master whitelist, blacklist, etc. are queried for an entry associated with the file. Note operation 518. As shown, the answer to the query (e.g. indicating whether the file is included in the whitelist, blacklist, etc.) is stored in a cache of the server (operation 520) and the answer is returned to the caller which requested the security status (operation 522). In this way, the determination of whether the security status is known (e.g. the method of FIG. 6) is completed, as shown in operation 524.

Still yet, the security status of the file is optionally stored in a cache of the parent server, as shown in operation 526. For example, the file (or a hash thereof) may be stored in a whitelist, blacklist, etc. cache of the parent server, based on the security status. In this way, the parent server may utilize the cache for increased speed in determining whether the security status of the file is known in response to a next query received by the parent server.

In addition, the security status is returned to the caller which sent the query. Note operation 528. As shown, operations 526 and 528 may be repeated for each server which determined that the security status was unknown, until the security status is returned down the hierarchy to the device via which the file was attempted to be accessed. In this way, each server and the device which via which the file was attempted to be accessed that determined that the security status was unknown may store the security status for future use. See operation 530. For example, in response to storing the security status of the file at the device which via which the file was attempted to be accessed, the file may be allowed (and optionally additional monitoring performed thereon) or disallowed from being accessed based on such security status (e.g. see decision 506 and operation 508).

FIG. 6 shows a method 600 for determining a security status of data, in accordance with still yet another embodiment. As an option, the method 600 may be carried out in the context of the architecture and environment of FIGS. 1-5. Of course, however, the method 600 may be carried out in any desired environment. Again, it should be noted that the aforementioned definitions may apply during the present description.

As shown in decision 602, it is determined whether a security status of a file is stored in a whitelist, blacklist, etc. cache. Thus, such determination may include determining whether the security status of the file is known. If it is determined that the security status of the file is stored in the whitelist, blacklist, etc. cache, the security status is returned to a caller which requested such security status. Note operation 626.

If, however, it is determined that the security status of the file is not stored in the whitelist, blacklist, etc. cache, a query for such security status is sent to a parent server, as shown in operation 604. Further, an answer to the query is returned to a caller which requested such security status, as shown in operation 606. As shown in decision 608, it is determined whether the answer is definitive.

If it is determined that the answer is not definitive (e.g. that the answer indicates a security status of the file and not that the answer indicates that the security status is unknown), it is determined whether the security status is in a local whitelist, blacklist, etc. cache. Note decision 610. The local whitelist, blacklist, etc. cache may include a whitelist, blacklist and/or a list of data for which additional monitoring is to be performed located on the parent server, for example.

If the security status is not in the local whitelist, blacklist, etc. cache, a local analysis engine is asked for such security status, as shown in operation 612. Thus, an analysis may be performed on the file for generating a security status thereof. In this way, either the generated security status or the security status found in the local whitelist, blacklist, etc. cache is stored in cache, as shown in operation 624, and the security status is returned to the caller that requested such security status, as shown in operation 626.

If it is determined that the answer is definitive in decision 608, it is further determined whether the answer originated from a super server or an intermediate parent server policy. Note decision 614. If the answer originated from the intermediate parent server policy, the answer is stored in cache (operation 624) and the answer is returned to the caller that requested such security status (operation 626).

If, however, the answer originated from the super server, it is determined whether the answer is in a local whitelist, blacklist, etc. cache, as shown in decision 616. If the answer is in a local whitelist, blacklist, etc. cache, the local answer is used. Note operation 618. Otherwise, if the answer is not in a local whitelist, blacklist, etc. cache, the answer from the super server is used. Note operation 620. Furthermore, the answer is stored in cache (operation 624) and the answer is returned to the caller that requested such security status (operation 626).

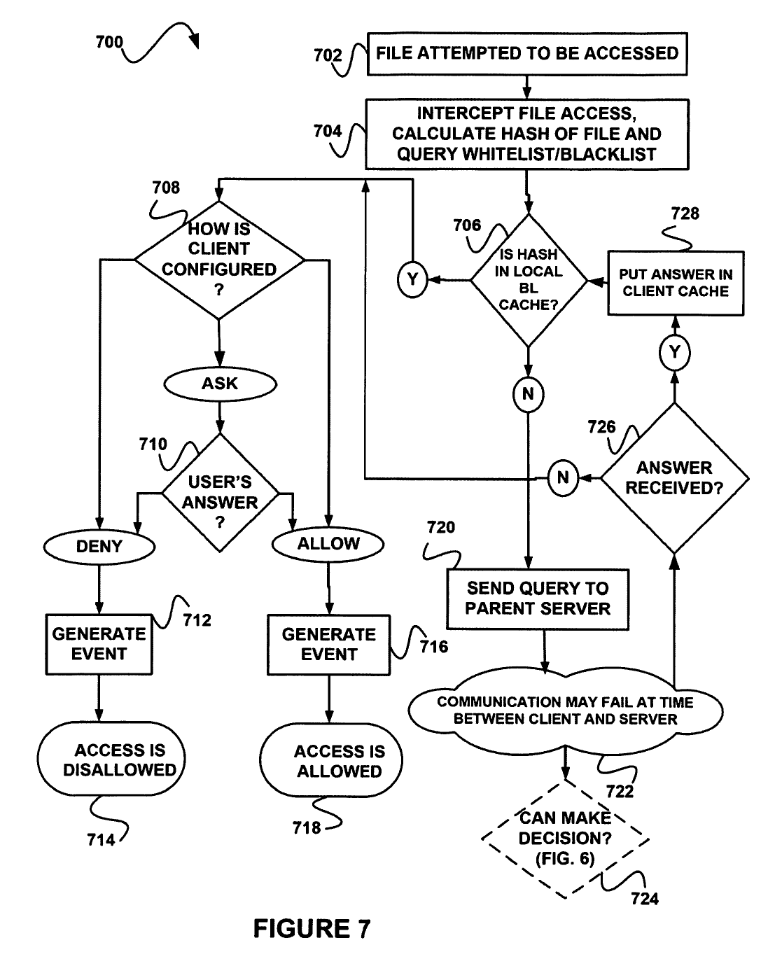

FIG. 7 shows a method 700 for utilizing a user interaction to determine a security status of data, in accordance with another embodiment. As an option, the method 700 may be carried out in the context of the architecture and environment of FIGS. 1-6. Of course, however, the method 700 may be carried out in any desired environment. Again, it should be noted that the aforementioned definitions may apply during the present description.

As shown in operation 702, a file is attempted to be accessed. With respect to the present embodiment, the attempted access to the file may include any desired type of access, such as opening the file, reading the file, etc. As an option, the file may be attempted to be accessed locally. As another option, the attempt to access the file may be identified by monitoring access requests associated with the file.

In one embodiment, the file may include an executable file, and the attempted access may include an attempt to execute the file. Just by way of example, the attempted access may be initiated by a user double clicking on the executable file. The user may include any user of a device via which an executable file may be selected to execute. For example, the double click of the executable file may be a request to initiate execution of the executable file.

Access to the file is intercepted, a hash of the file is calculated and a whitelist and blacklist of the device on which the file is located are queried. Note operation 704. In one embodiment, the access to the file may be intercepted by intercepting a request for the access to the file. In another embodiment, if the file is an executable file the access to the file may be intercepted by intercepting creation of a process associated with the access to the file. For example, the process which is intercepted may include a process to be utilized for executing the executable file, for example. In addition, the whitelist and blacklist may be stored in a cache and queried utilizing the calculated hash.

Further, it is determined whether the hash is included in a local blacklist cache, as shown in decision 706. If the hash is included in the local blacklist cache, it is further determined the manner in which the client device from which the file was attempted to be accessed is configured. With respect to the present embodiment, the configuration may include whether the client device is configured deny access to files included in the blacklist, allow access to files included in the blacklist, or ask the user whether to allow or deny such access. The configuration may be stored in a policy on the device, as an option. As another option, the configuration may be specified by an administrator.

If the client device is configured to deny the access, an event is generated (operation 712) and the access is disallowed (operation 714). If the client device is configured to allow the access, an event is generated (operation 716) and access is allowed (operation 718). If the client device is configured to ask the user whether to allow or deny such access, the user may be prompted for an instruction of whether to allow or deny the access (e.g. via a graphical user interface, a pop-up window, etc.). Based on the user instruction (decision 710), an event may be generated (operation 712) and the access disallowed (operation 714), or an event may be generated (operation 716) and the access allowed (operation 718). As an option, the generated event may include an alert, etc.

If it is determined in decision 706 that the hash is not in the local blacklist cache, a query for a security status of the executable file is sent to a parent server, as shown in operation 720. Further, it is determined whether the security status is known at the parent server, as shown in decision 724. For example, such determination may be made according to the method 600 described above with respect to FIG. 6. As an option, communication may fail during the time in which it is determined whether the security status is known at the parent server (see operation 722). Thus, it is determined in decision 726 whether an answer to the query for the security status is received.

If the answer is not received, the method 700 determines the manner in which the client device is configured (decision 708). In this way, a policy of the client device may be utilized to determine whether access to the file it to be allowed or disallowed. If, however, the answer is received, the answer is stored in a whitelist or blacklist cache of the client device (operation 728), according to whether the answer indicates that the security status of the file is that the file is allowed or disallowed to be accessed, respectively. It is again determined whether the hash is in the local blacklist cache (decision 706), in response to the storage of the answer.

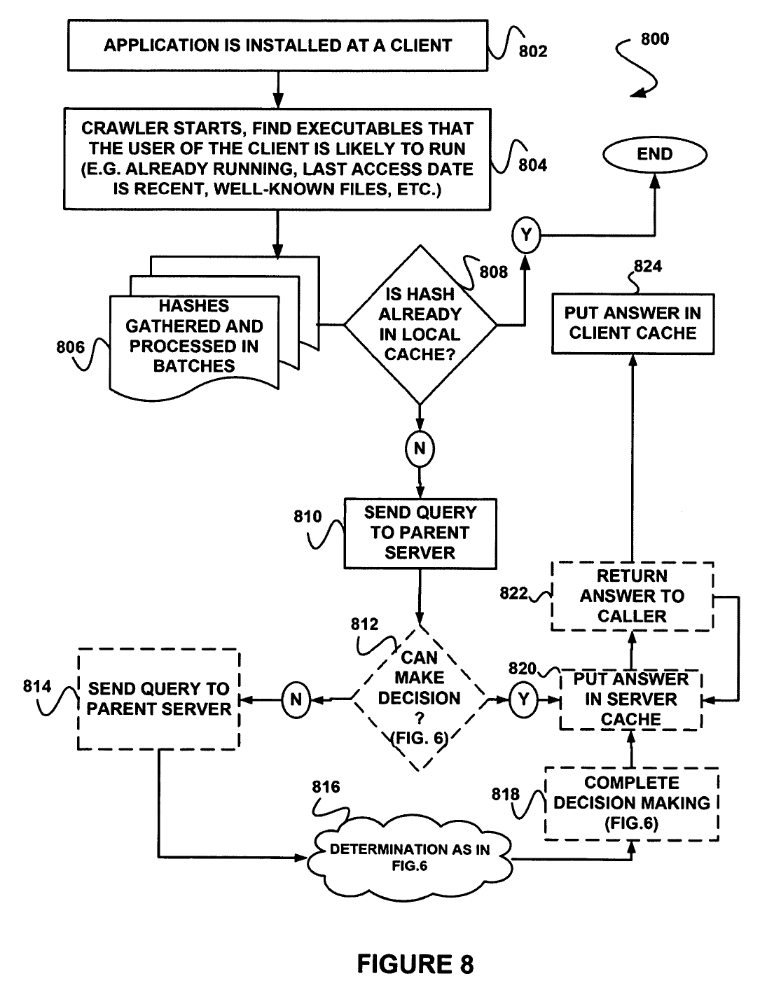

FIG. 8 shows a method 800 for selecting data for which to determine a security status thereof, in accordance with yet another embodiment. As an option, the method 800 may be carried out in the context of the architecture and environment of FIGS. 1-7. Of course, however, the method 800 may be carried out in any desired environment. Yet again, it should be noted that the aforementioned definitions may apply during the present description.

As shown in operation 802, an application is stored at a client device. The application may include any software, code, etc. As an option, the application may include an update to an application already existing on the client device.

Additionally, a crawler node starts and finds executables that a user of the client device is likely to run. Note operation 804. The executables may be determined to be likely to be run based on various criteria. For example, the client device may be determined to be likely to run executables already running, executables with a recent last access date, commonly accessed executables, etc. It should be noted that while executable file are disclosed with respect to the present embodiment, the crawler node may also identify any type of file that the user is determined to be likely to access.

Furthermore, hashes of each of such executables are gathered and processed in batches, as shown in operation 806. For each hash, it is determined whether such hash is already in a local whitelist or blacklist cache. Note decision 808. If the hash is already in a local whitelist or blacklist cache, the method 800 terminates with respect to such hash.

If, however, the hash is not already in a local whitelist or blacklist cache, a query for a security status of the hash is sent to a parent server, as shown in operation 810. Moreover, it is determined whether the security status of the hash is known at the parent server, as shown in decision 812. For example, such determination may be made utilizing the method 600 of FIG. 6.

If the security status of the hash is not known at the parent server, a query for the security status is sent to a next parent server, as shown in operation 814. The security status may be queried at each subsequent parent server in a hierarchical ordering of parent servers until it is determined that the security status is known at one of such parent servers (thus, operations 812-814) may optionally be repeated until it is determined that the security status is known or until a server at the highest point in the hierarchy determines that the security status is unknown (see operation 816). In this way, a security status of the executable file may be determined (operation 818).

If the security status of the hash is known at the parent server, or once the security status is determined (operation 818) the security status is stored in a whitelist or blacklist cache of the parent server (operation 820) and the security status is returned to a caller which requested such security status (operation 822). As shown, operations 820 and 822 may be repeated for each parent server in a hierarchical ordering of servers which determined that the security status is unknown. Moreover, the security status is further stored in a whitelist or blacklist cache of the client device, as shown in operation 824.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer program product embodied on a non-transitory computer readable medium, comprising:
computer code for receiving a request for a security status of data over a network from a client at a server;
computer code for determining whether the security status is known at the server using at least one of a whitelist and a blacklist;
computer code for transmitting a result of the determination over the network to the client from the server;
computer code for requesting from the client by the server additional information associated with the data if the result transmitted to the client indicates the security status is unknown at the server,
wherein the security status of the data identifies whether monitoring is to be performed during execution of the data.

2. The computer program product of claim 1, wherein the data includes an executable file.

3. The computer program product of claim 1, wherein the request is received in response to an attempt to execute the data.

4. The computer program product of claim 1, wherein the security status of the data identifies whether the data includes malware.

5. The computer program product of claim 1, wherein the security status of the data identifies whether the data is allowed to be executed.

6. (canceled)

7. The computer program product of claim 1, wherein the whitelist includes a list of data predetermined to be allowed to be executed.

8. The computer program product of claim 1, wherein the blacklist includes a list of data predetermined to be disallowed from being executed.

9. The computer program product of claim 1, wherein determining whether the security status is known at the server includes comparing the data to the at least one of the whitelist and the blacklist.

10. The computer program product of claim 1, wherein it is determined that the security status of the data is known at the server if the security status is determinable utilizing the at least one of the whitelist and the blacklist.

11. The computer program product of claim 1, wherein it is determined that the security status of the data is not known at the server if the security status is indeterminable utilizing the at least one of the whitelist and the blacklist.

12. The computer program product of claim 1, wherein the result of the determination includes one of the security status is known and the security status is unknown.

13. The computer program product of claim 12, wherein transmitting the result of the determination includes transmitting the security status if the security status is known.

14. (canceled)

15. The computer program product of claim 12, wherein transmitting the result of the determination includes transmitting a request for the security status to another server if the security status is unknown.

16. The computer program product of claim 15, wherein the other server includes a parent to the server in a hierarchical server structure.

17. The computer program product of claim 15, wherein the security status is stored in a cache at the server in response to a receipt of the security status from the other server.

18. A method, comprising:
receiving a request from a client for a security status of data over a network at a server;
determining whether the security status is known at the server using at least one of a whitelist and a blacklist;
transmitting a result of the determination over the network to the client from the server, and
requesting from the client by the server additional information associated with the data if the result transmitted to the client indicates the security status is unknown at the server, p1 wherein the security status of the data identifies whether monitoring is to be performed during execution of the data.

19. A system, comprising:
a processor for
receiving a request from a client for a security status of data over a network at a server,
determining whether the security status is known at the server using at least one of a whitelist and a blacklist,
transmitting a result of the determination over the network to the client from the server, and
requesting from the client by the server additional information associated with the data if the result transmitted to the client indicates the security status is unknown at the server,
wherein the security status of the data identifies whether monitoring is to be performed during execution of the data.

20. The system of claim 19, wherein the processor is coupled to memory via a bus.

21. The computer program product of claim 1, wherein the security status indicates a type of monitoring to be performed during execution.

22. The computer program product of claim 1, wherein the security status indicates a level of monitoring to be performed during execution.

23. The computer program product of claim 1, wherein the security status indicates that no monitoring is to be performed during execution.

24. The computer program product of claim 1, wherein the result of the determination comprises a security status of the data and a security status of a different data.

25. The computer program product of claim 24, wherein the different data is selected responsive to an identifier associated with the data in the at least one of a whitelist and a blacklist.

26. The computer program product of claim 1, further comprising:
computer code for determining that the client is in a predetermined state,
wherein the computer code for determining whether the security status is known at the server using at least one of a whitelist and a blacklist is executed without receiving a request for a security status from the client responsive to the determination that the client is in a predetermined state.

27. The computer program product of claim 26, wherein the data is selected according to a predetermined criteria.

28. The computer program product of claim 27, wherein the predetermined criteria comprises a probability of subsequent use of the data.

29. The computer program product of claim 27, wherein the predetermined criteria comprises prefetch information.

30. A computer program product embodied on a non-transitory computer readable medium, comprising:
computer code for transmitting a request for a security status of data from a client to a server;
computer code for receiving at the client a result of a determination by the server of the security status of the data;
computer code for providing additional information associated with the data responsive to a request received by the client from the server if the result received by the client indicates the security status of the data is unknown to the server.

31. The computer program product of claim 30, further comprising:
computer code to prevent transmitting the request for a security status to the server responsive to a determination that the data comprises sensitive data.

32. The computer program product of claim 31, further comprising:
computer code to allow an administrator to authorize transmitting the request for a security status of the sensitive data to the server.

33. The computer program product of claim 30, wherein the result of the determination comprises a security status of the data and a security status of a different data.

34. The computer program product of claim 30, wherein the result of the determination of the security status of the data received from the server is stored by the client.

35. A method, comprising:
receiving a first request for a security status of data from a client computer at a first server;
evaluating the security status of the data by the first server;
transmitting a second request from the first server to a second server if the security status of the data is unknown by the first server;
receiving a security status responsive to the second request from the second server if the security status of the data is known by the second server;
receiving a request for additional information associated with the data from the second server if the received security status indicates the security status of the data is unknown by the second server;
transmitting the security status to the client computer from the first server; and
transmitting the request for additional information associated with the data to the client computer from the first server if the security status transmitted to the client computer indicates the security status of the data is unknown by the second server.

36. The method of claim 35, further comprising:
receiving the additional information from the client computer by the first computer; and
transmitting the additional information from the first server to the second server.

37. The method of claim 35, further comprising:
storing the security status of the data by the first server responsive to receiving the security status from the second server.
